(19) United States
(12) Patent Application Publication
(10) Pub. No.: US 2015/0305562 A1
(43) Pub. Date: Oct. 29, 2015

(54) DUAL SIDED EGG COOKING APPARATUS

(71) Applicants: Bonita Garvin, Tool, TX (US); Jerry Garvin, Tool, TX (US)

(72) Inventors: Bonita Garvin, Tool, TX (US); Jerry Garvin, Tool, TX (US)

(21) Appl. No.: 14/264,095

(22) Filed: Apr. 29, 2014

(51) Int. Cl. A47J 37/10; A47J 37/06

(52) U.S. Cl. CPC A47J 37/10; A47J 37/0611

(57) ABSTRACT

A dual sided egg cooking apparatus for cooking egg mixtures on both sides and forming the egg mixture into a rectangular shape suitable to fit between slices of bread comprises a first cooking pan and a second cooking pan hingedly attached together by a hinge assembly. The first cooking pan and the second cooking pan are mirror images, each defined by elongated bodies having a hinge section, a rectangular pan section, and a handle section, respectively. When the dual sided egg cooking apparatus is in a closed position with the first cooking pan and the second cooking pan pressed together, an enclosure is formed in which an egg mixture to be cooked is placed. Once the cooking process is complete, the cooked egg mixture is formed in the shape of the rectangular pan sections of the first cooking pan and the second cooking pan.

### BACKGROUND OF THE INVENTION

1. Field of the Invention

This invention relates generally to cooking accessories and, more particularly, to a hinged, enclosing pan for cooking eggs structured to configure eggs into a desired shape as they are being cooked.

2. Description of the Prior Art

The use of conventional pans for cooking eggs is well known. While eggs are prepared and consumed in a wide variety of ways, one particularly popular way in which eggs are consumed is between two pieces of bread as a part of a sandwich. When preparing eggs in a conventional pan, however, it is often difficult to form the egg into a generally rectangular shape, which is conducive to being eating between two rectangular slices of bread in a sandwich. Indeed, when cooked in conventional pans, it is common for the cooked eggs to be formed in irregular shapes which are difficult to maintain between two pieces of bread. As a result, a significant portion of the egg may spill off the bread while a user is attempting to transport or consume the egg sandwich.

Thus, a problem which still exists is that existing pans are unable to form an egg into a desired rectangular shape for a sandwich while the egg is being cooked. Thus, there remains a need for a dual sided egg cooking apparatus would hold an egg mixture (one egg or a plurality of eggs) in a rectangular shape while it is being cooked, forming it into a rectangular body. It would be helpful if such a dual sided egg cooking apparatus enabled a user to flip the eggs while being cooked in order to cook an egg on both sides without disturbing the cooking or shape forming process. It would be additionally desirable for such a dual sided egg cooking apparatus to be defined by a hinged enclosure to allow a raw egg mixture to be securely held while cooking and a finished egg easily removed once cooked.

The Applicant's invention described herein provides for a dual sided egg cooking apparatus adapted to allow a user to cook an egg on both sides, forming it into a rectangular, bread size body. The primary components in Applicant's dual sided egg cooking apparatus are a two mirror image cooking pans and a hinge assembly. When in operation, the dual sided egg cooking apparatus enables more effective and efficient preparation of egg mixtures for consumption in egg sandwiches. As a result, many of the limitations imposed by prior art structures are removed.

### SUMMARY OF THE INVENTION

A dual sided egg cooking apparatus for cooking egg mixtures on both sides and forming the egg mixture into a rectangular shape suitable to fit between slices of bread. The dual sided egg cooking apparatus comprises a first cooking pan and a second cooking pan hingedly attached together by a hinge assembly. The first cooking pan and the second cooking pan are mirror images, each defined by elongated bodies having a hinge section, a rectangular pan section, and a handle section, respectively. When the dual sided egg cooking apparatus is in a closed position with the first cooking pan and the second cooking pan pressed together, an enclosure is formed in which an egg mixture to be cooked is placed. When an egg mixture is being cooked in the enclosure, either the first cooking pan or the second cooking pan can be placed on a heat source first, with the other side subsequently placed on the heat source to cook the egg mixture on both sides. Once the cooking process is complete, the cooked egg mixture is formed in the shape of the rectangular pan sections of the first cooking pan and the second cooking pan.

It is an object of this invention to provide a dual sided egg cooking apparatus would hold an egg mixture in a rectangular shape while it is being cooked, forming it into a rectangular body.

It is another object of this invention to provide a dual sided egg cooking apparatus which enables a user to flip the eggs while being cooked in order to cook an egg on both sides without disturbing the cooking or shape forming process.

It is yet another object of this invention to provide a dual sided egg cooking apparatus defined by a hinged enclosure to allow a raw egg mixture to be securely held while cooking and a finished egg easily removed once cooked.

These and other objects will be apparent to one of skill in the art.

### BRIEF DESCRIPTION OF THE DRAWINGS

FIG. 1 is a side elevational view of a dual sided egg cooking apparatus built in accordance with the present invention in the open position.

FIG. 2 is a front elevational view of the dual sided egg cooking apparatus built in accordance with the present invention in the closed position.

FIG. 3 is a top plan view of a first cooking pan of a dual sided egg cooking apparatus built in accordance with the present invention.

FIG. 4 is a top plan view of a second cooking pan of a dual sided egg cooking apparatus built in accordance with the present invention.

### DETAILED DESCRIPTION OF THE INVENTION

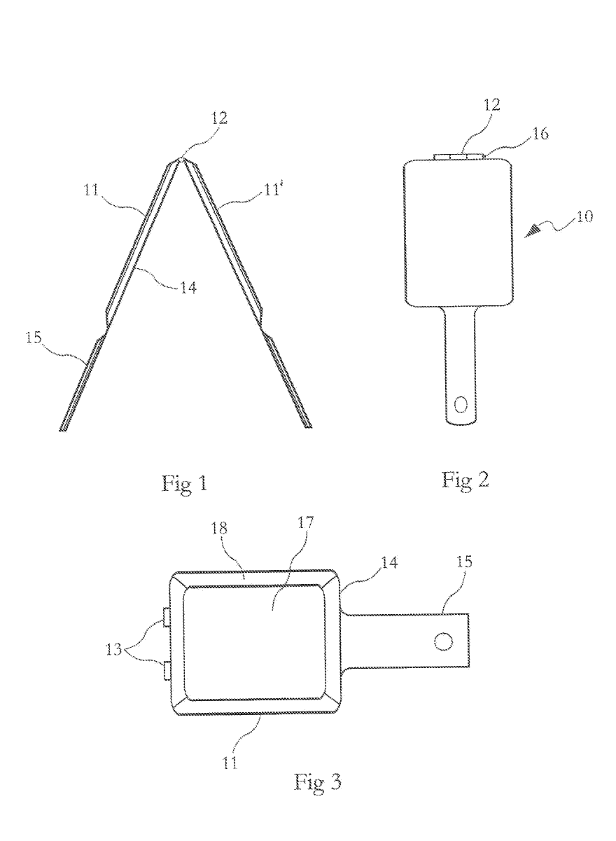

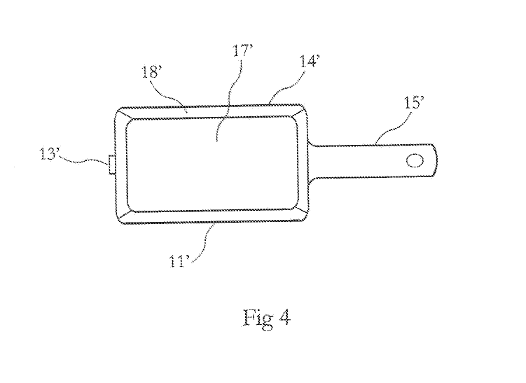

Referring now to the drawings and in particular FIGS. 1, 2, 3, and 4, a dual sided egg cooking apparatus 10 is shown having a first cooking pan 11 and a second cooking pan 11′ hingedly attached together by a hinge assembly 12. The first cooking pan 11 and the second cooking pan 11′ are identically sized pans that are shaped as mirror images of one another. The first cooking pan 11 and the second cooking pan 11′ are each defined by elongated bodies having a hinge section 13, 13′, a pan section 14, 14′, and a handle section 15, 15′, respectively. The hinge sections 13, 13′ on the first cooking pan 11 and the second cooking pan 11′, respectively, form the corresponding portions of the hinge assembly 12, so that when the hinge section 13 on the first cooking pan 11 is engaged with the hinge assembly 13′ on the second cooking pan 11′ and the hinge pin 16 is inserted, the hinge assembly 12 is operative to enable both the first cooking pan 11 and the second cooking pan 11′ to be swung about the axis created by the hinge pin 16. Such swinging action enables the dual sided egg cooking apparatus 10 to be moved from an open position, defined as a position where the respective pan sections 14, 14′ and handle sections 15, 15′ of the first cooking pan 11 and the second cooking pan 11′ are not touching, to a closed position defined as a position where the respective pan sections 14, 14′ and handle sections 15, 15′ of the first cooking pan 11 and the second cooking pan 11′ are touching.

The pan sections 14, 14′ are defined by a cooking area 17, 17′ surrounded on all sides by side walls 18, 18′. When the dual sided egg cooking apparatus 10 is in the closed position, the side walls 18, 18′ remain in contact, forming an enclosure in the cooking areas 17, 17′ in which an egg mixture being cooked is to be disposed and which will define the shape of the cooked egg mixture. When an egg mixture is being cooked in the enclosure, the first cooking pan 11 can be placed on the heat source first, cooking the egg mixture on one side, then the dual sided egg cooking apparatus 10 can be flipped over to having the second cooking pan 11′ on the heat source to cook the egg mixture on the other side. Once the cooking process is complete, the dual sided egg cooking apparatus 10 can be moved to an open position and the cooked egg mixture, formed in the shape of the cooking areas 17, 17′ can be slid out.

When the dual sided egg cooking apparatus 10 is in the closed position, the handle sections 15, 15′ are pressed together, forming a single structure that can be grasped by the hand of a user.

It is understood that the size and shape of the cooking areas 17, 17′ are to be slightly larger than a conventional slice of bread. In this regard, it is contemplated that the dual sided egg cooking apparatus 10 may be employed to cook slices of bread (such as french toast).

It is contemplated that the surface of the cooking areas 17, 17′ may be coated with a non-stick substance.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A dual sided egg cooking apparatus, comprising:
a first cooking pan having a first attachment section, a first cooking section, and a first handle section;
a second cooking pan having a second attachment section, a second cooking section, and a second handle section, wherein said first attachment section and said second attachment section are engaged, causing the first cooking pan and the second cooking pan to be movably connected; and
wherein a cooking enclosure is formed from the combined first cooking section the second cooking section when said first cooking section and first handle section are positioned to be touching the second cooking section and second handle section.

2. The dual sided egg cooking apparatus of claim 1, wherein said first attachment section and said section attachment section are defined by corresponding sections of a hinge assembly and the first cooking pan and the second cooking pan are hingedly attached.

3. The dual sided egg cooking apparatus of claim 1, wherein the first cooking section and the section cooking section are each defined by a cooking area surrounded on all sides by side walls and said cooking enclosure is formed when the sidewalls of the first cooking section are contacting the side walls of the second cooking section.
